(19) United States
(12) Patent Application Publication
(10) Pub. No.: US 2011/0305383 A1
(43) Pub. Date: Dec. 15, 2011

(54) APPARATUS AND METHOD PROCESSING THREE-DIMENSIONAL IMAGES

(76) Inventors: Jae Joon Lee, Seoul (KR); Du Sik Park, Suwon-si (KR); Ho Cheon Wey, Sengnam-si (KR)

(21) Appl. No.: 13/149,482

(22) Filed: May 31, 2011

(30) Foreign Application Priority Data
Jun. 10, 2010 (KR) 10-2010-0054755

(51) Int. Cl. G06K 9/36

(52) U.S. Cl. 382/154

(57) ABSTRACT

Provided is a 3D image processing apparatus and method. The 3D image processing apparatus may determine, with a small amount of calculation, a quantization parameter to be used for compressing a depth image, based on a quantization parameter used for compressing a color image and characteristics of the color image and the depth image.

### CROSS-REFERENCE TO RELATED APPLICATIONS

This application claims the benefit of Korean Patent Application No. 10-2010-0054755, filed on Jun. 10, 2010, in the Korean Intellectual Property Office, the disclosure of which is incorporated herein by reference.

### BACKGROUND

1. Field

One or more embodiments relate to a three-dimensional (3D) image processing apparatus and method, and more particularly, to a 3D image processing apparatus and method that may determine a quantization parameter to minimize a degradation of an image quality and the amount of data generated during compression.

2. Description of the Related Art

Recently, demand for three-dimensional (3D) images that allow users to view TV, movies, and the like, in 3D space has been rapidly increasing.

A stereoscopic image may be used to indicate a three-dimensional (3D) image by simultaneously providing depth information and spatial information with respect to a shape.

A 3D image processing apparatus may generate a 3D image corresponding to a predetermined point of view, by encoding color image and depth images of various points of view, the encoding operations may include respective decoding operations, such as to generate difference or disparity information that is ultimately encoded and output.

However, such 3D image processing apparatuses may compress and transmit the depth images from various points of view, and thus, in addition to the encoded color image information a substantial amount of processing may be performed in encoding the various point of view depth images, which may further result in the generation and output of each compressed various point of view depth image. This may result in a substantial amount of data being generated during compression and a substantial amount of data being output. Further, typically, when the image quality of a generated 3D image is less than or equal to a reference level, e.g., a predetermined level, the 3D image processing apparatus may further repeat the encoding of the depth images based on different quantization parameters and may repeatedly perform the process until a desired quality level is met through the varying attempted quantization parameters. Accordingly, the 3D image processing apparatus may repeatedly perform the encoding and decoding processes until a 3D image with a desired image quality is obtained, before the encoded 3D image is output. This repetition requires a substantial amount of processing power with increased number of calculations, which further requires a great amount of time.

### SUMMARY

According to one or more embodiments, and as an effect, a 3D image processing apparatus and method may allocate, with a small amount of calculation, an optimal quantization parameter to a color image and a depth image, when the color image and the depth image are compressed.

According to one or more embodiments, and as an effect, a quantization parameter of a depth image may be calculated based on a previously calculated relational expression and thus, an amount of calculation may be reduced compared with a conventional quantization parameter calculating method.

According to one or more embodiments, and as an effect, a relational expression to obtain a quantization parameter to be used for compressing a depth image may be previously calculated by a multiple regression analysis based on characteristics of the color image and the depth image. When a view image is generated using the color image and the depth image, a quality of the view image may be enhanced with small or limited bit requirements.

According to one or more embodiments, there is provided a three-dimensional (3D) image processing apparatus, the apparatus including a determining unit to determine an optimal depth quantization parameter, based on a determined color quantization parameter for encoding an input color image, an encoding unit to encode the input color image based on the determined color quantization parameter and to encode a input depth image, corresponding to the input color image, based on the determined optimal depth quantization parameter, and a decoding unit to decode the encoded color image and the encoded depth image.

According to one or more embodiments, there is provided a 3D image processing apparatus, apparatus including a characteristic extracting unit to determine a complexity of an input color image and determine a complexity of an input depth image, an encoding unit to encode the input color image and the input depth image based on a determined color quantization parameter, a decoding unit to decode the encoded color image and the encoded depth image, and a determining unit to determine an optimal depth quantization parameter to be used for encoding the input depth image, based on at least one of the determined color quantization parameter, the determined complexity of the input color image, the determined complexity of the input depth image, a determined amount of generated bit data of the encoded color image, a determined amount of generated bit data of the encoded depth image, and a determined amount of generated bit data of the decoded color image.

According to one or more embodiments, there is provided a 3D image processing apparatus, the apparatus including a characteristic extracting unit to determine a complexity of an input color image and determine a complexity of an input depth image, an encoding unit to encode the input color image and the input depth image based on a determined color quantization parameter, a decoding unit to decode the encoded color image and the encoded depth image, and a relational expression calculating unit to calculate a relational expression to obtain an optimal depth quantization parameter, by applying, to a regression analysis, at least one of the determined complexity of the input color image, the determined complexity of the input depth image, a determined amount of generated bit data of the encoded color image, a determined amount of generated bit data of the encoded depth image, and a determined amount of generated bit data of the decoded color image, wherein the optimal depth quantization parameter is to be used to encode the input depth image.

According to one or more embodiments, there is provided a 3D image processing method, the method including determining an optimal depth quantization parameter based on a determined color quantization parameter, encoding an input color image based on the determined color quantization parameter and encoding an input depth image based on the optimal depth quantization parameter, and decoding the encoded color image and the encoded depth image.

According to one or more embodiments, there is provided a 3D image processing apparatus, the apparatus including a color decoding unit to decode an encoded color image, encoded based on a color quantization parameter, and a depth decoding unit to decode the encoded depth image based on an optimal depth quantization parameter having a defined relationship to the color quantization parameter, as defined in a corresponding encoding of the depth image to the encoded depth image.

According to one or more embodiments, there is provided a 3D image processing method, the method including decoding an encoded color image, encoded based on a color quantization parameter, and decoding the encoded depth image based on an optimal depth quantization parameter having a defined relationship to the color quantization parameter, as defined in a corresponding encoding of the depth image to the encoded depth image.

One or more embodiments provide a three-dimensional (3D) image processing apparatus, the apparatus including an encoding unit to encode a depth image using a quantization parameter not based on the depth image, and a determining unit to determine an optimal depth quantization parameter based on a determined relationship between the quantization parameter not based on the depth image and determined characteristics of a color image corresponding to the depth image and at least one decoding of the encoded depth image, wherein the encoding unit encodes the depth image based on the determined optimal depth quantization parameter.

One or more embodiments provide a three-dimensional (3D) image processing method, the method including encoding a depth image using a quantization parameter not based on the depth image, determining an optimal depth quantization parameter based on a determined relationship between the quantization parameter not based on the depth image and determined characteristics of a color image corresponding to the depth image and at least one decoding of the encoded depth image, and encoding the depth image based on the determined optimal depth quantization parameter.

Additional aspects, features, and/or advantages of embodiments will be set forth in part in the description which follows and, in part, will be apparent from the description, or may be learned by practice of the disclosure.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 illustrates a three-dimensional (3D) image processing apparatus, according to one or more embodiments;

FIG. 2 illustrates a 3D image processing apparatus, according to one or more embodiments;

FIG. 3 illustrates a 3D image processing apparatus, according to one or more embodiments;

FIG. 4 illustrates a relational expression calculating method, such as method that may be implemented in the 3D image processing apparatus of FIG. 1, according to one or more embodiments;

FIG. 5 illustrates a 3D image processing method, such as a 3D image processing method that may be implemented in the 3D image processing apparatus of FIG. 2, according to one or more embodiments;

FIG. 6 illustrates a 3D image processing apparatus, according to one or more embodiments; and

FIG. 7 illustrates a 3D image processing method, such as a 3D image processing method that may be to be implemented in the 3D image processing apparatus of FIG. 6, according to one or more embodiments.

### DETAILED DESCRIPTION

Reference will now be made in detail to one or more embodiments, illustrated in the accompanying drawings, wherein like reference numerals refer to like elements throughout. In this regard, embodiments of the present invention may be embodied in many different forms and should not be construed as being limited to embodiments set forth herein. Accordingly, embodiments are merely described below, by referring to the figures, to explain aspects of the present invention.

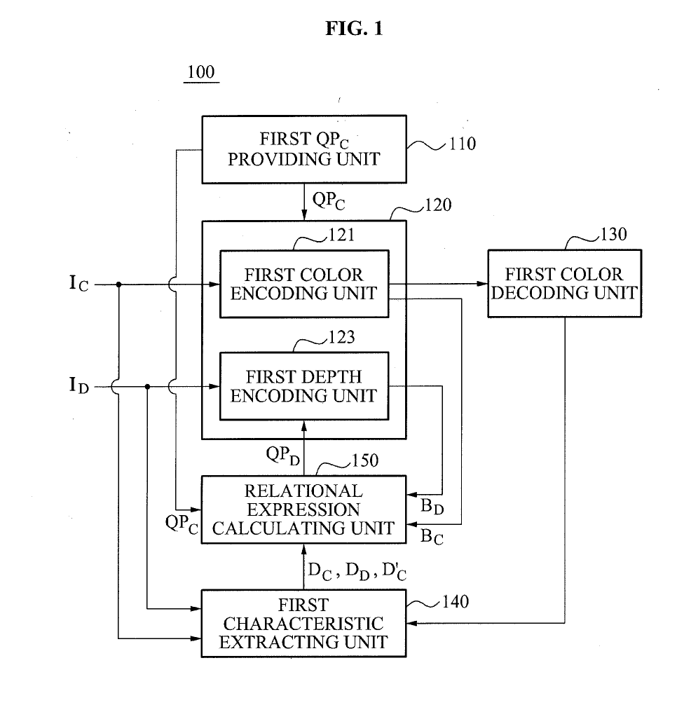

FIG. 1 illustrates a three-dimensional (3D) image processing apparatus 100, according to one or more embodiments.

In one or more embodiments, when an input color image I_{C} is encoded a select quantization parameter may be determined, e.g., the color quantization parameter QP_{C}, such as for obtaining a desired level of quality with the compression of the input color image I_{C} and/or with a desired limited or minimum amount of data, or other factors, for example. In an embodiment, this determining of the color quantization parameter QP_{C} is not based on the input depth image I_{D}. Using this color quantization parameter QP_{C}, the input depth image I_{D} may then be encoded, e.g., with the 3D image processing apparatus 100 calculating a relational expression that may then be used to calculate an optimal depth quantization parameter (QP_{D}) to be applied to the input depth image I_{D}. As only an example, the optimal depth quantization parameter QP_{D} may be selected to be a value that minimizes the degradation of an image quality of the 3D image generated by the encoding and decoding processes and/or minimizes the amount of generated data, e.g., the resultant output bit data and/or number of bits needed to represent any one compressed item.

Referring to FIG. 1, the 3D image processing apparatus 100 may include a first QP_{C} providing unit 110, a first encoding unit 120, a first color decoding unit 130, a first characteristic extracting unit 140, and a relational expression calculating unit 150, for example.

The first QP_{C} providing unit 110 may provide the color quantization parameter QP_{C}, determined for use in the encoding of the input color image I_{C}, to the first encoding unit 120, e.g., to a first color encoding unit 121 and a first depth encoding unit 123, and the relational expression calculating unit 150.

As noted, in one or more embodiments, the first encoding unit 120 may include the first color encoding unit 121 and the first depth encoding unit 123, or if the first color encoding unit 121 and the first depth encoding unit 123 are in distinct devices, for example, the input color quantization parameter QP_{C} may be separately provided to both the first color encoding unit 121 and the first depth encoding unit 123. The first color encoding unit 121 may receive the input color image I_{C} and the determined color quantization parameter QP_{C}. The first color encoding unit 121 may encode the input color image I_{C} based on the color quantization parameter QP_{C}, and may further determine the amount of generated bit data, represented by indicator B_{C}, of the encoded color image, i.e., as encoded. The generated bit data amount indicator B_{C} may indicate a size of encoded data, namely, an amount or size of compressed data. As noted above, herein, the term ‘amount of generated bit data’ represents the amount or size of the resultant compressed information, such as the resultant encoded input color image I_{C} and/or the resultant encoded input depth image I_{D}, and may similarly represent the number of bits used in encoding each compressed item representing the values of the input color image I_{C} and/or input depth image I_{D}. Accordingly, the encoded color image may be provided to the first color decoding unit 130 and the generated bit data amount indicator B_{C} may be provided to the relational expression calculating unit 150.

The first depth encoding unit 123 may receive the input depth image I_{D} and a color quantization parameter corresponding to an input color image. In one or more embodiments, this color quantization parameter received by the first depth encoding unit 123 may be the color quantization parameter QP_{C} that was provided to the first color encoding unit 121, e.g., from the first QP_{C} providing unit 110. The first depth encoding unit 123 may temporarily-encode the input depth image I_{D} based on the color quantization parameter QP_{C} and may determine an amount of generated bit data, represented by indicator B_{D}, of the encoded depth image. The generated bit data amount indicator B_{D} may be then be provided to the relational expression calculating unit 150.

The generated bit data amount indicator B_{C} and the generated bit data amount indicator B_{D} may be determined based on separate hardware or element, or determined by the same hardware or element.

The first color decoding unit 130 may decode the encoded color image and may provide the decoded color image to the first characteristic extracting unit 140.

The first characteristic extracting unit 140 may extract, i.e., determine, a complexity of the input color image I_{C}, represented by complexity indicator D_{C}, a complexity of the input depth image, represented by complexity indicator D_{D}, and an extracted/determined, e.g., by the first characteristic extracting unit 140, complexity of the decoded color image, represented by the complexity indicator D′_{C}. Therefore, the complexity indicator D_{C} and complexity indicator D_{D} may be respectively extracted from the input color image I_{C} and the input depth image I_{D} before either image is encoded. In one or more embodiments, the complexity indicator D′_{C} of the decoded color image may be extracted from a separate characteristic extracting unit as the first characteristic extracting unit 140, which extracts the complexity indicator D_{C} of the input color image I_{C}, a complexity identifier D_{D} of the input depth image.

In one or more embodiments, the determined complexity indicators, e.g., respective variances, may represent image characteristic values indicating the respective complexity of a color image and a depth image, as well as of the decoded color image. The determined variance represents the extent of dispersion of pixels within an image. The depth image may be an image representing the depth of each of the pixels of the depth image as a gray value, for example, and may be composed of mostly even areas or areas with a same or similar depth, e.g., with the determination of such a similarity being based upon the relative differences in depth for neighboring depth pixels, as only example. Therefore, the depth image may have relatively less change in pixel values than a corresponding color image, and thus may have a relatively lower dispersion or variance between pixels than the color image. The complexity indicator D_{C}, the complexity indicator D_{D} and the complexity indicator D′_{C} may be provided to the relational expression calculating unit 150.

As noted, in one or more embodiments, the relational expression calculating unit 150 may receive the color quantization parameter QP_{C} from the first QP_{C} providing unit 110, and may receive the complexity indicator D_{C}, the complexity indicator D_{D}, and the complexity indicator D′_{C} from the first characteristic extracting unit 140. The relational expression calculating unit 150 may further receive the generated bit data amount indicator B_{C} from the first color encoding unit 121, and may receive the generated bit data amount indicator B_{D} from the first depth encoding unit 123.

The relational expression calculating unit 150 may apply, to a regression analysis, at least one of the color quantization parameter QP_{C}, the complexity indicator D_{C}, the complexity indicator D_{D}, the generated bit data amount indicator B_{C}, the generated bit data amount indicator B_{D}, and the complexity indicator D′_{C} to calculate the relational expression and to calculate the optimal depth quantization parameter QP_{D}. The calculated optimal depth quantization parameter QP_{D} may be used to encode the depth image.

Input images may include difference image characteristics, for example, different internal variances, and may result in different amounts of bit data being generated during compression. The relational expression calculating unit 150 may calculate a relation, i.e., a defined relationship, between a characteristic of each of the images, an amount of bit data generated during an encoding process, and characteristics of decoded images. When an image is input, the calculated relation may be used to calculate an optimal quantization parameter to be applied to the input depth image. The relational expression calculating unit 150 may calculate the relational expression based on a multiple regression analysis.

The multiple regression analysis, which is an extended regression analysis, may use at least two regression models, for example. A multiple regression analysis used by the relational expression calculating unit 150 may be represented by the below Equation 1, for example.

y=a₀+a₁x₁+a₂x₂+a₃x₃+a₄x₄+a₅x₅+a₆x₆ Equation 1:

Equation 1 may be modified to form the below Equation 2, for example.

y=ax

a=[a₀a₁a₂a₃a₄a₅a₆]

x=[1x₁x₂x₃x₄x₅x₆]^{T} Equation 2:

In Equation 2, ‘a’ and ‘x’ may denote vectors, and ‘a’ may be a coefficient to be calculated by the multiple regression analysis. As ‘x’ may denote a parameter, ‘y’ may denote a parameter corresponding to ‘x’ or may denote a depth quantization parameter corresponding to a color quantization parameter among ‘x’.

In one or more embodiments, ‘y’ may be a value that minimizes a degradation of image quality and the amount of bit data generated while the depth image is encoded when the color quantization parameter is ‘10’, for example. Additionally, in an embodiment, ‘y’ may be predetermined by experimentation, and before encoding of either of the input color or depth images. The relational expression calculating unit 150 may calculate ‘a’ based on ‘y’ and ‘x’, and may apply the obtained ‘a’ to Equation 1 and thus, may calculate the relational expression to be used for obtaining the optimal depth quantization parameter QP_{D}. The relational expression calculating unit may further then calculate the optimal depth quantization parameter QP_{D} and provide the same to the first depth encoding unit, e.g., for a final encoding of the depth image for output.

As only examples, ‘x’ may be represented by the below Equation 2.1, for example.

$$\begin{matrix}x = [ \begin{matrix}1 \\ Color quantization parameter \\ Complexity of color image \\ Complexity of depth image \\ Complexity of decoded color image \\ Amount of generated bit of color image \\ Amount of generated bit of depth image\end{matrix} ] \\ = [ \begin{matrix}1 \\ {QP}_{C} \\ {D}_{C} \\ {D}_{D} \\ {D}_{D}^{′} \\ {B}_{C} \\ {B}_{D}\end{matrix} ] \\ = {[ \begin{matrix}1 & {QP}_{C} & {D}_{C} & {D}_{D} & {D}_{D}^{′} & {B}_{C} & {B}_{D}\end{matrix} ]}^{T}\end{matrix} \qquad Equation 2.1$$

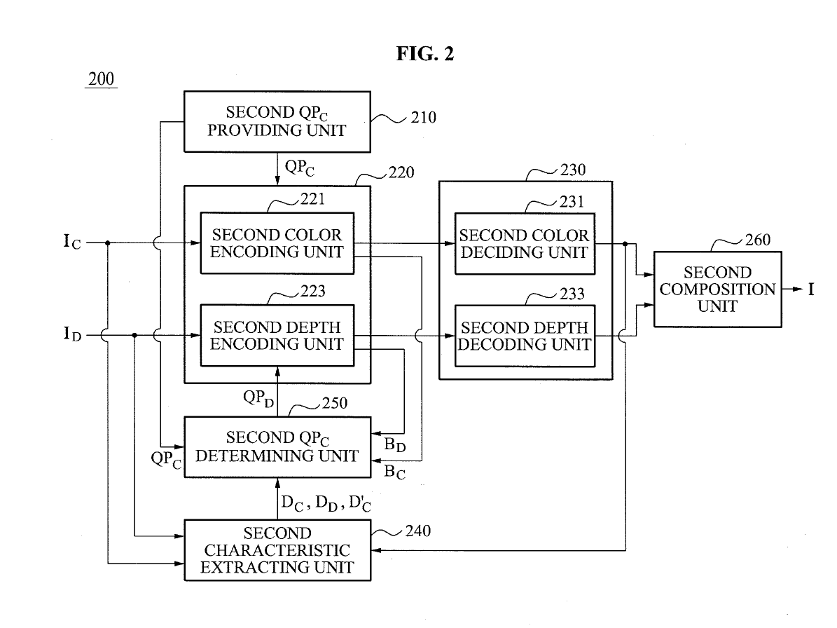

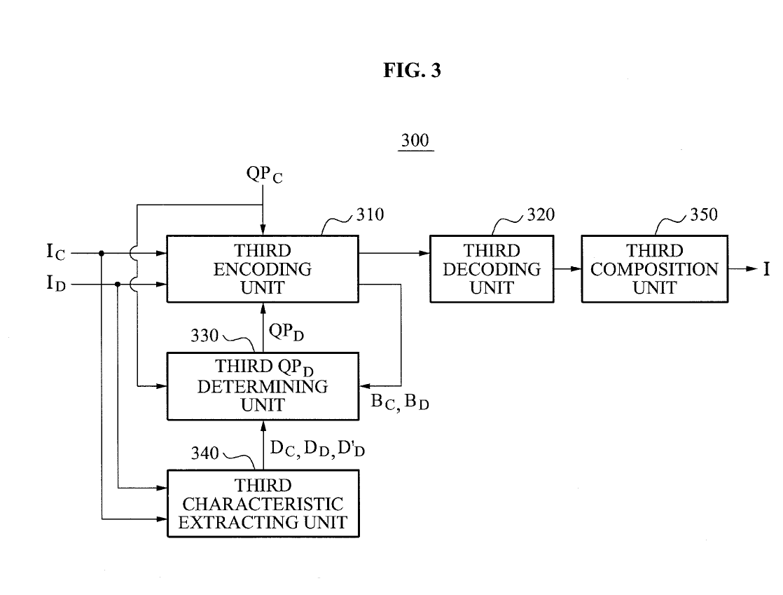

In Equation 2.1, the values ‘1’ may denote an intercept, and ‘x’ may denote a parameter used for determining an optimal depth quantization parameter QP_{D}, e.g., in an apparatus to be described below with reference to FIGS. 2 and 3. For example, when the color image is encoded using the color quantization parameter QP_{C} (QP_{C}=20), the value of the depth quantization parameter to be used for encoding the depth image may affect the total amount of generated bit data and affect the image quality of any resulting generated 3D image.

As shown above in Equation 2.1, ‘x’ may include six parameters, as only an example. Such six parameters may be the color quantization parameter QP_{C}, the complexity indicator D_{C}, the complexity indicator D_{D}, the generated bit data amount indicator B_{C}, the generated bit data amount indicator B_{D}, and the complexity indicator D′_{C}. The generated bit data amount indicator B_{C} may represent the amount of bit data generated when the color image is encoded, and the generated bit data amount indicator B_{D} may represent the amount of bit data generated when the depth image is encoded. In this example, the depth image may initially be temporarily encoded based on the same color quantization parameter QP_{C}. Herein, in one or more embodiments, the use of the term ‘temporarily-encoded’ for the encoding of the input depth image or ‘temporarily-decoded’ for the encoding or decoding of the input color image and input depth image means an encoding or decoding that is performed within the encoding, for example, and the resultant temporarily encoded or temporarily decoded images are not respectively output as the encoded color image or the encoded depth image, and are not composed together to generate a view image I, as referenced further below.

When ‘x’ is obtained, the relational expression calculating unit 150 may calculate ‘a’ based on the below Equation 3, for example.

a=x⁻¹y Equation 3:

In Equation 3, x⁻¹ may be a reciprocal number of x=[1 x₁ x₂ x₃ x₄ x₅ x₆]^{T}=[1 QP_{C} D_{C} D_{D} D′_{D} B_{C} B_{D}]^{T}, such as the above Equation 2.1, and thus, X⁻¹ and ‘y’ may be already known. Accordingly, the relational expression calculating unit 150 may substitute x⁻¹ and ‘y’ in Equation 3 to calculate ‘a’, and may substitute ‘a’ in Equation 1 to calculate the relational expression to be used for calculating the optimal depth quantization parameter QP_{D}, e.g., for an optimal encoding of the input depth image I_{D} to be output with the encoded input color image In this example, the relational expression calculating unit 150 may calculate various ‘x’, by changing the color quantization parameter QP_{C} and thus, may calculate various ‘a’ corresponding various ‘x’.

In this example, an optimal ‘a’ may be determined based on the various ‘a’ and thus, a reliability of the determined optimal ‘a’ may increase.

FIG. 2 illustrates a 3D image processing apparatus 200, according to one or more embodiments.

A 3D image may need depth images of various points in view to enable the viewer to feel as though the 3D image is viewed in a different direction, when the viewer changes the viewer's point of view. A 3D image processing apparatus may encode and decode a color image and various depth images of various points of view to generate a 3D image corresponding to an arbitrary point of view.

The 3D image processing apparatus 200 of FIG. 2 may be an apparatus to determine an optimal depth quantization parameter QP_{D} to be used for encoding a depth image based on a previously calculated relational expression. The relational expression may be calculated by the image processing apparatus 100 of FIG. 1. Operations of the image processing apparatus 100 of FIG. 1, operated to calculate the relational expression, may be applicable to the image processing apparatus 200 of FIG. 2.

Referring to FIG. 2, the 3D image processing apparatus 200 may include a second QP_{C} providing unit 210, a second encoding unit 220, a second decoding unit 230, a second characteristic extracting unit 240, a second QP_{D} determining unit 250, and a second composition unit 260, for example.

The second QP_{C} providing unit 210 may provide a color quantization parameter QP_{C}, to be used for encoding an input color image I_{C}, to a second color encoding unit 221, a second depth encoding unit 223, and a second QP_{D} determining unit 250.

The second encoding unit 220 may include a second color encoding unit 221 and a second depth encoding unit 223. The second color encoding unit 221 may receive the input color image I_{C} and an input color quantization parameter QP_{C}. The second color encoding unit 221 may temporarily-encode the color image I_{C} based on the color quantization parameter QP_{C}, and may determine an amount of generated bit data, represented by indicator B_{C}, of the temporarily-encoded color image. The temporarily-encoded color image may be provided to the first color decoding unit 130 and the generated bit data amount indicator B_{C} may be provided to the second QP_{D} determining unit 250.

The second depth encoding unit 223 may receive an input depth image I_{D} and a color quantization parameter QP_{C}. In this stage, as only an example, the color quantization parameter QP_{C} provided to the second depth encoding unit 223 may be the same color quantization parameter QP_{C} provided to the second color encoding unit 221.

The second depth encoding unit 223 may temporarily-encode the input depth image I_{D} based on the color quantization parameter QP_{C}, and may determine an amount of generated bit data, represented by indicator B_{D}, of the temporarily-encoded depth image. The temporarily-encoded depth image may be provided to the second depth decoding unit 233, and the generated bit data amount indicator B_{D} may be provided to the second QP_{D} determining unit 250.

The second color decoding unit 221 may decode the encoded color image and may provide the decoded color image to the second characteristic extracting unit 240.

The second characteristic extracting unit 240 may extract a complexity indicator D_{C} of the input color image I_{C} and a complexity indicator D_{D} of the input depth image I_{D}. The second characteristic extracting unit 240 may extract a complexity indicator D′_{C} of the decoded color image from the second decoding unit 221. As noted, the complexity indicator may be an indicator of the variance within the image. The complexity indicator D_{C}, the complexity indicator D_{D}, and the complexity indicator D′_{C} may be provided to the second QP_{D} determining unit 250.

The second QP_{D} determining unit 250 may determine an optimal depth quantization parameter QP_{D} corresponding to the color quantization parameter QP_{C} based on at least one ‘x’ and the relational expression calculated by the relational expression calculating unit 150 of FIG. 1. The second QP_{D} determining unit 250 may substitute ‘x’ in Equation 1 and thus, ‘y’, namely, the optimal depth quantization parameter QP_{D} may be calculated. In this example, ‘a’ in Equation 1 is previously known.

Here, ‘x’ may include at least one of the color quantization parameter QP_{C} from the second QP_{C} providing unit 210, the generated bit data amount indicator B_{C}, the generated bit data amount indicator B_{D}, the complexity indicator D_{C}, the complexity indicator D_{D}, and the complexity indicator D′_{C}. For example, when ‘a’=[a₀ a₁ a₂], the second QP_{D} determining unit 250 may substitute three parameters, ‘x’, in the relational expression.

When the optimal depth quantization parameter QP_{D} is calculated, the second depth encoding unit 223 may re-encode a depth image based on the calculated optimal depth quantization parameter QP_{D}.

The second depth decoding unit 223 may re-decode the re-encoded depth image.

The second composition unit 260 may compose the decoded color image that is previously decoded in the second color decoding unit 221 and the re-decoded depth image, and may output a view image I. The view image I may be an image at an arbitrary point of view, generated based on the input color image I_{C} and the input depth image I_{D}. When the color image and the depth image are images captured at a location A, the view image I may be an image corresponding to a location B, which is not actually captured.

FIG. 3 illustrates a 3D image processing apparatus 300, according to one or more embodiments.

The 3D image processing apparatus 300 of FIG. 3 may be similar to the 3D image processing apparatus 200 of FIG. 2, and thus, potentially overlapping detailed description thereof will be omitted.

Referring to FIG. 3, the 3D image processing apparatus 300 may include a third encoding unit 310, a third decoding unit 320, a third characteristic extracting unit 330, a third QP_{D} determining unit 340, and a third composition unit 350.

The third encoding unit 310 may encode an input color image I_{C} and an input depth image I_{D} based on the same color quantization parameter QP_{C}. The third encoding unit 310 may determine an amount of generated bit data, represented by indicator B_{C}, of the encoded color image and an amount of generated bit data, represented by indicator B_{D}, of the encoded depth image. The encoded color image may be provided to the first color decoding unit 130 and the generated bit data amount indicator B_{C} and the generated bit data amount indicator B_{D} may be provided to the third QP_{D} determining unit 340.

The third decoding unit 320 may decode the encoded color image and the encoded depth image, and may provide the decoded color image to the third characteristic extracting unit 330.

The third characteristic extracting unit 330 may extract a complexity indicator D_{C} of the input color image I_{C} and a complexity indicator D_{D} of the input depth image I_{D}. The third characteristic extracting unit 330 may extract a complexity indicator D′_{D} of the decoded color image. The complexity indicator D_{C}, the complexity indicator D_{D}, the complexity indicator D′_{D} extracted by the third characteristic extracting unit 330 may be provided to the third QP_{D} determining unit 340.

The third QP_{D} determining unit 340 may determine an optimal depth quantization parameter QP_{D} corresponding to the color quantization parameter QP_{C}, based on the relational expression calculated by 3D image processing apparatus 100 and six parameters, ‘x’. The third QP_{D} determining unit 340 may substitute six parameters, ‘x’, in Equation 1 to calculate the optimal depth quantization parameter QP_{D}. In this example, ‘a’ in Equation 1 is previously known.

The six parameters, ‘x’, may be the color quantization parameter QP_{C}, the generated bit data amount indicator B_{C}, the generated bit data amount indicator B_{D}, the complexity indicator D_{C}, the complexity indicator D_{D}, and the complexity indicator D′_{D}, for example.

When the optimal depth quantization parameter QP_{D} is calculated, the third encoding unit 310 may re-encode the input depth image I_{D} based on the calculated optimal depth quantization parameter QP_{D}.

The third decoding unit 320 may re-decode the re-encoded depth image.

The third composition unit 350 may compose the decoded color image that is previously decoded in the third decoding unit 320 and the re-decoded depth image, to output a view image I.

According to the 3D image processing apparatuses 200 and 300, the 3D image processing apparatuses 200 and 300 may simply calculate an optimal depth quantization parameter QP_{D} corresponding to a color quantization parameter QP_{C} based on a previously obtained relational expression. The optimal depth quantization parameter QP_{D} may be calculated based on various characteristics of a color image and a depth image and thus, a degradation of image quality and an amount of generated bit data may be minimized.

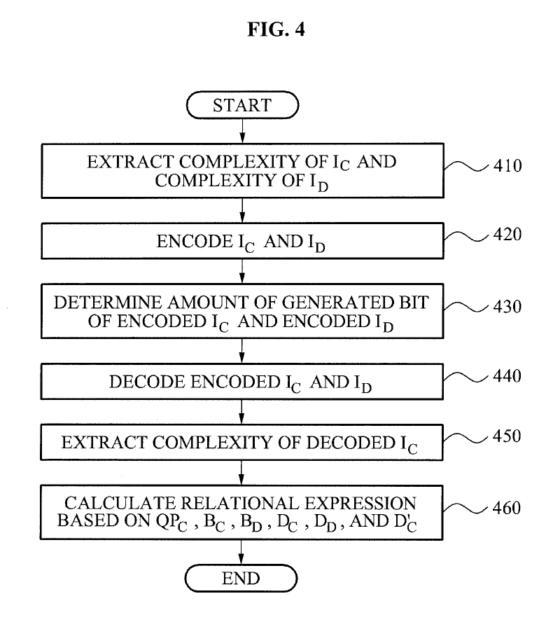

FIG. 4 illustrates a relational expression calculating method, such as a relational expression calculating method that may be implemented by the 3D image processing apparatus 100 of FIG. 1, as only an example, according to one or more embodiments.

In operation 410, a complexity, for example, a variance, may be extracted from each of an input color image I_{C} and an input depth image I_{D}, and in one or more embodiments namely, a complexity indicator D_{C} for the input color image I_{C} and a complexity indicator D_{D} for the input depth image I_{D} may be extracted/determined.

In operation 420, the input color image I_{C} and the input depth image I_{D} are encoded based on a color quantization parameter QP_{C}.

In operation 430, an amount of generated bit data, represented by indicator B_{C}, of the encoded color image and an amount of generated bit data, represented by indicator B_{D}, of the encoded depth image may be determined.

In operation 440, the encoded color image and the encoded depth image may be decoded.

In operation 450, a complexity of the decoded color image may be extracted/determined, and represented by a complexity indicator D′_{C}.

In operation 460, a relational expression may be calculated, to be used for calculating an optimal depth quantization parameter QP_{D}, based on at least one of the color quantization parameter QP_{C}, the complexity indicator D_{C}, the complexity indicator D_{D}, the generated bit data amount indicator B_{C}, the generated bit data amount indicator B_{D}, and the complexity indicator D′_{C}. The relational expression may be expressed by Equation 1, for example.

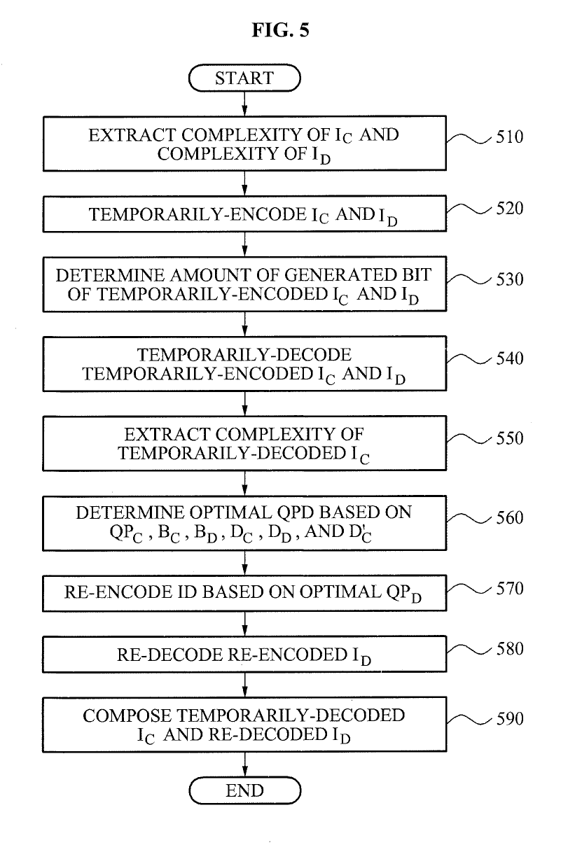

FIG. 5 illustrates an example of a 3D image processing method, such as a 3D processing method that may be implemented by the 3D image processing apparatus 200 of FIG. 2, according to one or more embodiments.

In operation 510, a complexity indicator D_{C} of an input color image I_{C} and a complexity indicator D_{D} of an input depth image I_{D} may be extracted/determined.

In operation 520, the input color image I_{C} and the input depth image I_{D} may be temporarily-encoded based on the color quantization parameter QP_{C}.

In operation 530, an amount of generated bit data, represented by indicator B_{C}, of the temporally-encoded color image and an amount of generated bit data, represented by indicator B_{D}, of the temporarily-encoded depth image may be determined.

In operation 540, the temporarily-encoded color image and the temporarily-encoded depth image are decoded.

In operation 550, the 3D image processing apparatus 200 extracts a complexity, represented by indicator D′_{C}, of the temporarily-decoded color image.

In operation 560, the optimal depth quantization parameter QP_{D} may be calculated by substituting, in a previously obtained relational expression, at least one of the color quantization parameter QP_{C}, the complexity indicator D_{C}, the complexity indicator D_{D}, the generated bit data amount indicator B_{C}, the generated bit data amount indicator B_{D}, and the complexity indicator D′_{C}, i.e., without having to calculate the relational expression completely anew.

In operation 570, the input depth image I_{D} may be re-encoded based on the calculated optimal depth quantization parameter QP_{D}.

In operation 580, the re-encoded depth image may be re-decoded.

In operation 590, the temporarily-encoded color image of operation 520 and the re-decoded depth image of operation 580 may be composed, to generate a view image. One or more embodiments further include an output or transmission hardware or element, such as included in any of the color encoding or depth encoding units, to generate the view image and output or transmit the generated view image. The output view image may be stored in a volatile or non-volatile memory, e.g., the first encoding unit of FIG. 1 may include such a memory and operation 590 may include storing the view image to the memory. The temporarily-encoded input color image and input depth image may also be stored in a volatile or non-volatile memory, which similarly may be included in the first encoding unit of FIG. 1.

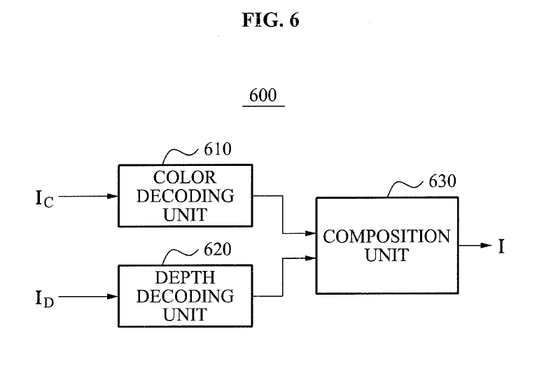

FIG. 6 illustrates a 3D image processing apparatus 600, according to one or more embodiments.

The 3D image processing apparatus 600 is used to decode an encoded color image and an encoded depth image which have been encoded according to the one or more embodiments herein. For example, the color image and depth image may be encoded by the 3D image processing apparatus 200 of FIG. 2, or encoded according to one or more processes set forth in FIG. 5. The 3D image processing apparatus 600 may include a color decoding unit 610, a depth decoding unit 620, and a composition unit 630, for example.

The color decoding unit 610 may decode the encoded color image based on a color quantization parameter QP_{C}. The encoded color image may be encoded, by the 3D image processing apparatus 200, based on the color quantization parameter QP_{C}.

The depth decoding unit 620 may decode the encoded depth image based on an optimal depth quantization parameter. The optimal depth quantization parameter may have a value calculated based on the color quantization parameter QP_{C} that is used for encoding a color image. The encoded depth image may be an image that is encoded, by the 3D image processing apparatus 200, for example, based on the optimal depth quantization parameter.

The optimal depth quantization parameter may be a value obtained by applying, to a multiple regression analysis, at least one of the color quantization parameter, a determined complexity of an original color image, a determined complexity of an original depth image, a determined complexity of a decoded color image, a determined amount of the generated bit data of the encoded color image, and a determined amount of the generated bit data of the encoded depth image, encoded based on the color quantization parameter.

The composition unit 630 may compose the decoded color image decoded by the color decoding unit 610 and the decoded depth image decoded by the depth decoding unit 620, to output a view image I. The view image I may be an image at an arbitrary point of view, generated based on the input color image and the input depth image I_{D}. In one or more embodiments, the composition unit includes a display to output the view image I, a volatile or non-volatile memory to store the view image I, and/or output or transmission hardware or element to provide the view image I to a display, for example.

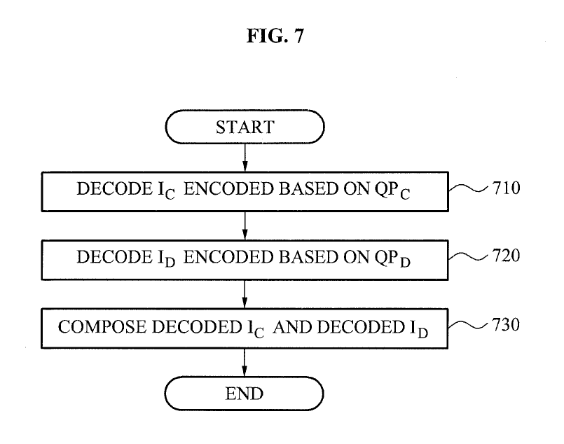

FIG. 7 illustrates a 3D image processing method, such as a 3D image processing method that may be implemented by the 3D image processing apparatus 600 of FIG. 6, according to one or more embodiments.

In operation 710, an encoded color image, which is encoded based on a color quantization parameter QP_{C}, may be decoded.

In operation 720, an encoded depth image, which is encoded based on an optimal depth quantization parameter, may be decoded. The optimal depth quantization parameter may have a value calculated based on the color quantization parameter used for encoding a color image. In operation 730, the decoded color image and the decoded depth image may be composed to generate a view image I. The view image I may be an image at an arbitrary point of view, generated based on the input color image and the input depth image I_{D}. In one or more embodiments, operation 730 includes displaying the view image I, storing the view image, such as in volatile or non-volatile memory, and/or outputting or transmitting the view image I. The view image may be output or transmitted to a display, as only an example.

In one or more embodiments, any apparatus, system, and unit descriptions herein include one or more hardware devices and/or hardware processing elements/devices. In one or more embodiments, any described apparatus, system, and unit may further include one or more desirable memories, and any desired hardware input/output transmission devices, as only examples. Further, the term apparatus should be considered synonymous with elements of a physical system, not limited to a device, i.e., a single device at a single location, or enclosure, or limited to all described elements being embodied in single respective element/device or enclosures in all embodiments, but rather, depending on embodiment, is open to being embodied together or separately in differing devices or enclosures and/or differing locations through differing hardware elements.

In addition to the above described embodiments, embodiments can also be implemented through computer readable code/instructions in/on a non-transitory medium, e.g., a computer readable medium, to control at least one processing element/device, such as a processor, computing device, computer, or computer system with peripherals, to implement any above described embodiment. The medium can correspond to any defined, measurable, and tangible structure permitting the storing and/or transmission of the computer readable code. Additionally, one or more embodiments include the at least one processing element or device.

The media may also include, e.g., in combination with the computer readable code, data files, data structures, and the like. One or more embodiments of computer-readable media include magnetic media such as hard disks, floppy disks, and magnetic tape; optical media such as CD ROM disks and DVDs; magneto-optical media such as optical disks; and hardware devices that are specially configured to store and/or perform program instructions, such as read-only memory (ROM), random access memory (RAM), flash memory, and the at least one processing device, respectively. Computer readable code may include both machine code, such as produced by a compiler, and files containing higher level code that may be executed by the computer using an interpreter, for example. The media may also be any defined, measurable, and tangible elements of one or more distributed networks, so that the computer readable code is stored and/or executed in a distributed fashion. In one or more embodiments, such distributed networks do not require the computer readable code to be stored at a same location, e.g., the computer readable code or portions of the same may be stored remotely, either stored remotely at a single location, potentially on a single medium, or stored in a distributed manner, such as in a cloud based manner. Still further, as noted and only as an example, the processing element could include a processor or a computer processor, and processing elements may be distributed and/or included in a single device. There may be more than one processing element and/or processing elements with plural distinct processing elements, e.g., a processor with plural cores, in which case one or more embodiments would include hardware and/or coding to enable single or plural core synchronous or asynchronous operation.

The computer-readable media may also be embodied in at least one application specific integrated circuit (ASIC) or Field Programmable Gate Array (FPGA), as only examples, which execute (processes like a processor) program instructions.

While aspects of the present invention has been particularly shown and described with reference to differing embodiments thereof, it should be understood that these embodiments should be considered in a descriptive sense only and not for purposes of limitation. Descriptions of features or aspects within each embodiment should typically be considered as available for other similar features or aspects in the remaining embodiments. Suitable results may equally be achieved if the described techniques are performed in a different order and/or if components in a described system, architecture, device, or circuit are combined in a different manner and/or replaced or supplemented by other components or their equivalents.

Thus, although a few embodiments have been shown and described, with additional embodiments being equally available, it would be appreciated by those skilled in the art that changes may be made in these embodiments without departing from the principles and spirit of the invention, the scope of which is defined in the claims and their equivalents.

What is claimed is:

1. A three-dimensional (3D) image processing apparatus, the apparatus comprising:
a determining unit to determine an optimal depth quantization parameter, based on a determined color quantization parameter for encoding an input color image;
an encoding unit to encode the input color image based on the determined color quantization parameter and to encode a input depth image, corresponding to the input color image, based on the determined optimal depth quantization parameter; and
a decoding unit to decode the encoded color image and the encoded depth image.

2. The apparatus of claim 1, wherein:
the encoding unit temporarily-encodes the input color image and the input depth image, based on the determined color quantization parameter; and
the determining unit determines the optimal depth quantization parameter further based on a determined amount of generated bit data of the temporarily-encoded color image and a determined amount of generated bit data of the temporarily-encoded depth image.

3. The apparatus of claim 2, wherein:
the decoding unit temporarily-decodes the temporarily-encoded color image and the temporarily-encoded depth image; and
the determining unit determines the optimal depth quantization parameter further based on a determined complexity of the temporarily-decoded color image.

4. The apparatus of claim 3, wherein the determined complexity represents a variance within the temporarily-decoded color image.

5. The apparatus of claim 3, further comprising:
a characteristic extracting unit to determine a complexity of the input color image and to determine a complexity of the input depth image,
wherein the determining unit determines the optimal depth quantization parameter further based on the determined complexity of the input color image and the determined complexity of the input depth image.

6. The apparatus of claim 5, wherein the determined complexity of the input color image represents a variance within the input color image and the determined complexity of the input depth image represents a variance within the input depth image.

7. The apparatus of claim 5, wherein the determining unit determines the optimal depth quantization parameter based on a depth quantization parameter relational expression that is obtained by applying, to a regression analysis, at least one of the determined color quantization parameter, the determined amount of generated bit data of the temporarily-encoded color image, the determined amount of generated bit data of the temporarily-encoded depth image, the determined complexity of the temporarily-decoded color image, the determined complexity of the input color image, and the determined complexity of the input depth image.

8. A 3D image processing apparatus, apparatus comprising:
a characteristic extracting unit to determine a complexity of an input color image and determine a complexity of an input depth image;
an encoding unit to encode the input color image and the input depth image based on a determined color quantization parameter;
a decoding unit to decode the encoded color image and the encoded depth image; and
a determining unit to determine an optimal depth quantization parameter to be used for encoding the input depth image, based on at least one of the determined color quantization parameter, the determined complexity of the input color image, the determined complexity of the input depth image, a determined amount of generated bit data of the encoded color image, a determined amount of generated bit data of the encoded depth image, and a determined amount of generated bit data of the decoded color image.

9. The apparatus of claim 8, wherein:
the encoding unit re-encodes the decoded depth image based on the determined optimal depth quantization parameter; and
the decoding unit re-decodes the re-encoded depth image.

10. A 3D image processing apparatus, the apparatus comprising:
a characteristic extracting unit to determine a complexity of an input color image and determine a complexity of an input depth image;
an encoding unit to encode the input color image and the input depth image based on a determined color quantization parameter;
a decoding unit to decode the encoded color image and the encoded depth image; and
a relational expression calculating unit to calculate a relational expression to obtain an optimal depth quantization parameter, by applying, to a regression analysis, at least one of the determined complexity of the input color image, the determined complexity of the input depth image, a determined amount of generated bit data of the encoded color image, a determined amount of generated bit data of the encoded depth image, and a determined amount of generated bit data of the decoded color image,
wherein the optimal depth quantization parameter is to be used to encode the input depth image.

11. A 3D image processing method, the method comprising:
determining an optimal depth quantization parameter based on a determined color quantization parameter;
encoding an input color image based on the determined color quantization parameter and encoding an input depth image based on the optimal depth quantization parameter; and
decoding the encoded color image and the encoded depth image.

12. The method of claim 11, further comprising:
temporarily-encoding the input color image and the input depth image based on the determined color quantization parameter;
wherein the determining of the optimal depth quantization parameter comprises determining the optimal-quantization parameter further based on a determined amount of generated bit data of the temporarily-encoded color image and a determined amount of generated bit data of the temporarily-encoded depth image.

13. The method of claim 12, further comprising:
temporarily-decoding the temporarily-encoded color image and the temporarily-encoded depth image,
wherein the determining comprises determining the optimal depth quantization parameter further based on a determined complexity of the temporarily-decoded color image.

14. The method of claim 13, wherein the determined complexity of the temporarily-decoded color image represents a variance within the temporarily-decoded color image.

15. The method of claim 13, further comprising:
determining a complexity of the input color image and a complexity of the input depth image,
wherein the determining of the optimal depth quantization parameter comprises determining the optimal depth quantization parameter further based on the determined complexity of the input color image and the determined complexity of the input depth image.

16. The method of claim 16, wherein the determined complexity of the input color image represents a variance within the input color image and the determined complexity of the input depth image represents a variance within the input depth image.

17. The method of claim 15, wherein the determining comprises calculating the optimal depth quantization parameter based on a depth quantization parameter relational expression obtained by applying, to a regression analysis, at least one of the determined color quantization parameter, the determined amount of generated bit data of the temporarily-encoded color image, the determined amount of generated bit data of the temporarily-encoded depth image, the determined complexity of the temporarily-decoded color image, the determined complexity of the input color image, and the determined complexity of the input depth image.

18. A 3D image processing apparatus, the apparatus comprising:
a color decoding unit to decode an encoded color image encoded based on a color quantization parameter; and
a depth decoding unit to decode the encoded depth image encoded based on an optimal depth quantization parameter having a defined relationship to the color quantization parameter, as defined in a corresponding encoding of the depth image to the encoded depth image.

19. The apparatus of claim 18, wherein the defined relationship is based on the optimal depth quantization parameter having been calculated by applying, to a regression analysis, at least one of the color quantization parameter, a determined complexity of an original color image, a determined complexity of an original depth image, a determined complexity of the decoded color image, a determined amount of generated bit data of the encoded color image, a determined amount of generated bit data of the encoded depth image that is encoded based on the color quantization parameter.

20. A 3D image processing method, the method comprising:
decoding an encoded color image encoded based on a color quantization parameter; and
decoding the encoded depth image encoded based on an optimal depth quantization parameter having a defined relationship to the color quantization parameter, as defined in a corresponding encoding of the depth image to the encoded depth image.

21. The method of claim 20, wherein the defined relationship is based on the optimal depth quantization parameter having been calculated by applying, to a regression analysis, at least one of the color quantization parameter, a determined complexity of an original color image, a determined complexity of an original depth image, a determined complexity of the decoded color image, a determined amount of generated bit data of the encoded color image, a determined amount of generated bit data of the encoded depth image that is encoded based on the color quantization parameter.

22. A three-dimensional (3D) image processing apparatus, the apparatus comprising:
an encoding unit to encode a depth image using a quantization parameter not based on the depth image; and
a determining unit to determine an optimal depth quantization parameter based on a determined relationship between the quantization parameter not based on the depth image and determined characteristics of a color image corresponding to the depth image and at least one decoding of the encoded depth image,
wherein the encoding unit encodes the depth image based on the determined optimal depth quantization parameter.

23. The apparatus of claim 22, wherein the encoding unit further encodes the color image using the color quantization parameter not based on the depth image, and composes the encoded color image and the encoded depth image encoded based on the determined optimal depth quantization parameter as a single view image.

24. The apparatus of claim 22, wherein the determined characteristics of the color image and the at least one decoding of the encoded depth image are respective variance characteristics of the color image and the at least one decoding of the encoded depth image.

25. The apparatus of claim 22, wherein the determined relationship is between the quantization parameter not based on the depth image, the determined characteristics of the color image and the at least one decoding of the encoded depth image, and a determined characteristic of the depth image, and
wherein the determined characteristics are respective pixel variance characteristics within each of the color image, the depth image, and the at least one decoding of the encoded depth image.

26. A three-dimensional (3D) image processing method, the method comprising:
encoding a depth image using a quantization parameter not based on the depth image;
determining an optimal depth quantization parameter based on a determined relationship between the quantization parameter not based on the depth image and determined characteristics of a color image corresponding to the depth image and at least one decoding of the encoded depth image; and
encoding the depth image based on the determined optimal depth quantization parameter.

27. The method of claim 26, further comprising:
encoding the color image using the color quantization parameter not based on the depth image; and
composing the encoded color image and the encoded depth image encoded based on the determined optimal depth quantization parameter as a single view image.

28. The method of claim 26, wherein the determined characteristics of the color image and the at least one decoding of the encoded depth image are respective variance characteristics of the color image and the at least one decoding of the encoded depth image.

29. The method of claim 26, wherein the determined relationship is between the quantization parameter not based on the depth image, the determined characteristics of the color image and the at least one decoding of the encoded depth image, and a determined characteristic of the depth image, and
wherein the determined characteristics are respective pixel variance characteristics within each of the color image, the depth image, and the at least one decoding of the encoded depth image.
